(19) United States
(12) Patent Application Publication
(10) Pub. No.: US 2022/0294802 A1
(43) Pub. Date: Sep. 15, 2022

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Hiroshi YANAGITA, Kanagawa (JP)

(73) Assignee: FUJIFILM Business Innovation Corp., Tokyo (JP)

(21) Appl. No.: 17/401,475

(22) Filed: Aug. 13, 2021

(30) Foreign Application Priority Data
Mar. 10, 2021 (JP) 2021-038403

(51) Int. Cl. H04L 29/06

(52) U.S. Cl. CPC H04L 63/105; H04L 63/0815

(57) ABSTRACT

An information processing apparatus includes: a processor configured to: receive authentication information for using a group that manages use of a service; and when the received authentication information does not satisfy a first current condition that is a condition of authentication information to which a condition having a highest security level is applied, for each item of a condition of the authentication information defined for each group to which a user belongs, present information that prompts to change the authentication information.

### CROSS-REFERENCE TO RELATED APPLICATIONS

This application is based on and claims priority under 35 USC 119 from Japanese Patent Application No. 2021-038403 filed Mar. 10, 2021.

### BACKGROUND

### (i) Technical Field

The present disclosure relates to an information processing apparatus, a non-transitory computer readable medium, and an information processing method.

### (ii) Related Art

JP-A-2020-042502 discloses an information processing apparatus including an authenticator that authenticates a user so that the user accesses plural resources on a network, and an acquirer that acquires conditions that are related to a strength of authentication information provided differently for the respective resources. The information processing apparatus further includes a controller that controls, when the user accesses one resource out of the plural resources, access to the one resource based on a condition related to the strength for the one resource and strength information on the strength of the authentication information of the user.

### SUMMARY

A technique allows the user to use the services corresponding to all the groups to which the user belongs, among groups that perform management related to use of services, through a single authentication process. With this technique, when the user belongs to plural groups and conditions of authentication information are defined for each group, the user needs to follow conditions of authentication information defined for a group the user joined first, conditions of authentication information defined by default, or the like in the authentication process. Since the conditions of the authentication information are defined for each group, a security level is also defined for each group. Therefore, when the user uses a group that has conditions of authentication information requiring a higher security level than the conditions of the authentication information that need to be followed, the security level cannot be maintained because the user does not need to follow the conditions requiring a higher security level.

Aspects of non-limiting embodiments of the present disclosure relate to maintaining a security level defined for each group even when a user belongs to plural groups.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a processor configured to: receive authentication information for using a group that manages use of a service; and when the received authentication information does not satisfy a first current condition that is a condition of authentication information to which a condition having a highest security level is applied, for each item of a condition of the authentication information defined for each group to which a user belongs, present information that prompts to change the authentication information.

### BRIEF DESCRIPTION OF THE DRAWINGS

Exemplary embodiment(s) of the present disclosure will be described in detail based on the following figures, wherein:

FIG. 1 is a schematic diagram showing an example of a hardware configuration of an information processing system according to an exemplary embodiment;

FIG. 2 is a schematic diagram showing an example of a hardware configuration of an information processing apparatus according to the exemplary embodiment;

FIG. 3 is a schematic diagram showing an example of a configuration of a tenant database according to the exemplary embodiment;

FIG. 4 is a schematic diagram showing an example of a configuration of a user database according to the exemplary embodiment;

FIG. 5 is a flowchart showing an example of information processing according to the exemplary embodiment;

FIG. 6 is a schematic diagram showing an example of a first authentication information change screen according to the exemplary embodiment;

FIG. 7 is a schematic diagram showing an example of a second authentication information change screen according to the exemplary embodiment;

FIG. 8 is a schematic diagram showing an example of a third authentication information change screen according to the exemplary embodiment;

FIG. 9 is a flowchart showing an example of a current policy deriving process according to the exemplary embodiment;

FIG. 10 is a flowchart showing an example of a user policy registration process according to the exemplary embodiment;

FIG. 11 is a schematic diagram showing an example of a user policy registration screen according to the exemplary embodiment;

FIG. 12 is a schematic diagram showing an example of a user policy re-registration screen according to the exemplary embodiment;

FIG. 13 is a flowchart showing an example of a user setting process according to the exemplary embodiment;

FIG. 14 is a schematic diagram showing an example of a user setting screen according to the exemplary embodiment;

FIG. 15 is a flowchart showing an example of a policy setting process according to the exemplary embodiment;

FIG. 16 is a schematic diagram showing an example of an applicable policy screen according to the exemplary embodiment;

FIG. 17 is a schematic diagram showing an example of a policy setting screen according to the exemplary embodiment;

FIG. 18 is a flowchart showing an example of a policy change process according to the exemplary embodiment; and

FIG. 19 is a schematic diagram showing an example of a policy change screen according to the exemplary embodiment.

### DETAILED DESCRIPTION

Hereinafter, an example of an exemplary embodiment of the present disclosure will be described with reference to the drawings. The same reference numerals are given to the same or equivalent elements and parts in each drawing. Dimensional ratios in the drawings are exaggerated for convenience of description and may differ from the actual ratios.

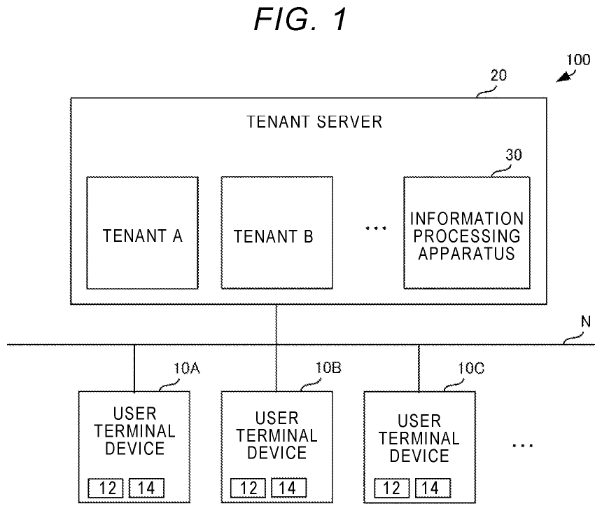

As shown in FIG. 1, an information processing system 100 according to the present exemplary embodiment includes plural user terminal devices 10A, 10B, 10C, and so on, and a tenant server 20. Hereinafter, when the plural user terminal devices 10A, 10B, 10C, and so on are described without being distinguished from one another, the plural user terminal devices are collectively referred to simply as “user terminal devices 10”.

The user terminal devices 10 and the tenant server 20 can communicate with each other via a communication unit N. In the present exemplary embodiment, a communication line in a company such as a local area network (LAN) or a wide area network (WAN) is used as the communication unit N. In addition, as the communication unit N, a public communication line such as the Internet or a telephone line may be used, or a combination of a communication line in a company and the public communication line may be used. In the present exemplary embodiment, a wired communication line is used as the communication unit N. In addition, as the communication unit N, a wireless communication line may be used, or a combination of wired and wireless communication lines may be used.

The user terminal device 10 according to the present exemplary embodiment is an information processing terminal that is connected to the tenant server 20 via the communication unit N and can use a service to be described later. In the present exemplary embodiment, a personal computer is used as the user terminal device 10. In addition, any information processing terminal such as a tablet terminal or a smartphone may be used as the user terminal device 10.

The user terminal device 10 according to the present exemplary embodiment includes an input unit 12 and a display 14.

The input unit 12 includes a pointing device such as a mouse and a keyboard, and is used to receive various kinds of input information.

The display 14 is, for example, a liquid crystal display, and displays various information. The display 14 may include a touch panel to serve as the input unit 12.

The tenant server 20 according to the present exemplary embodiment is a server that manages, by a multi-tenant management method, authority for a user to use a service on the communication unit N by using the user terminal device 10. In the present exemplary embodiment, the service on the communication unit N (hereinafter, simply referred to as a “service”) is a cloud service or a web service. In addition, the service may be any service provided by resources such as hardware, software, and data that can be used by the user via the communication unit N.

The multi-tenant management method is a management method in which plural tenants (tenant A and tenant B in the example shown in FIG. 1) indicating groups that perform management on use of a service are set, and authority for using the service is managed for each tenant. In the present exemplary embodiment, the management on the use of the service includes the management of a user who can use the service, and the management of authority of the user.

A user belonging to a tenant can use a service corresponding to the tenant to which the user belongs. In the present exemplary embodiment, a case where one tenant manages one service will be described.

A company under a contract with a tenant sets an administrator (hereinafter, referred to as an “administrator”) for managing the tenant. The administrator performs registration and deletion of a user belonging to a managed tenant, setting of conditions of authentication information for the user belonging to the tenant to use a corresponding service, and the like.

The tenant server 20 according to the present exemplary embodiment includes a build-in information processing apparatus 30. In the present exemplary embodiment, a server computer is used as the information processing apparatus 30. In addition, any information processing apparatus such as a personal computer may be used as the information processing apparatus 30. The tenant server 20 and the information processing apparatus 30 may be provided separately.

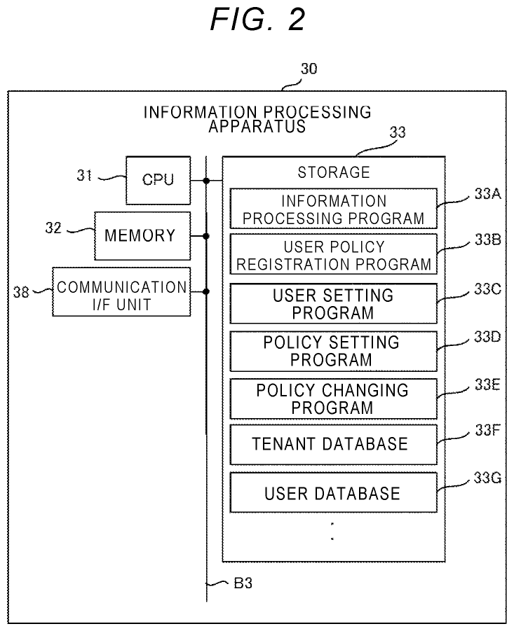

As shown in FIG. 2, the information processing apparatus 30 according to the present exemplary embodiment includes a CPU 31, a memory 32 as a temporary storage area, a non-volatile storage 33, and a communication I/F unit 38. The components are connected to each other via a bus B3.

The storage 33 is implemented by a storage device such as an HDD, an SSD, or a flash memory. The storage 33 as a storage medium stores an information processing program 33A, a user policy registration program 33B, a user setting program 33C, a policy setting program 33D, and a policy changing program 33E. The CPU 31 reads these programs from the storage 33, expands the programs in the memory 32, and sequentially executes processes included in the programs. The execution of each program will be described in detail later. The storage 33 stores various databases such as a tenant database 33F and a user database 33G.

The communication I/F unit 38 is an interface with which the information processing apparatus 30 communicates with an external device such as the user terminal device 10. For the communication, for example, a wired communication standard such as Ethernet (registered trademark) or FDDI, or a wireless communication standard such as 4G, 5G, or Wi-Fi (registered trademark) is used.

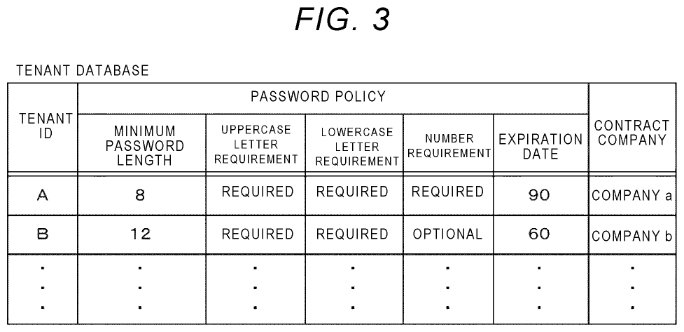

Next, the tenant database 33F according to the present exemplary embodiment will be described with reference to FIG. 3. In the tenant database 33F shown in FIG. 3, tenant information that is information on a tenant managed by the tenant server 20 is stored. In FIG. 3, each row represents the respective tenant information item. In each tenant information item, information items of a tenant ID, a password policy, and a contract company are associated with each other.

The “tenant ID” is information for individually identifying a tenant, and is an ID that is assigned in advance as information different for each tenant.

The “password policy” is information indicating conditions of authentication information for a user to use a service corresponding to the corresponding tenant. In the present exemplary embodiment, the password policy includes the minimum length of authentication information (hereinafter, referred to as “minimum password length”) and whether the use of an uppercase letter is required (hereinafter, referred to as “uppercase letter requirement”). In the present exemplary embodiment, the password policy further includes whether the use of a lowercase letter (hereinafter, referred to as “lowercase letter requirement”), whether the use of a number (hereinafter, referred to as “number requirement”), and an expiration date of the authentication information (hereinafter, simply referred to as “expiration date”). The password policy may include conditions such as whether the use of a symbol is required, and the maximum number of times the same authentication information can be used. The password policy may include only one of these conditions or a combination of plural conditions.

The “contract company” is information indicating the name of a company with which the corresponding tenant contracts.

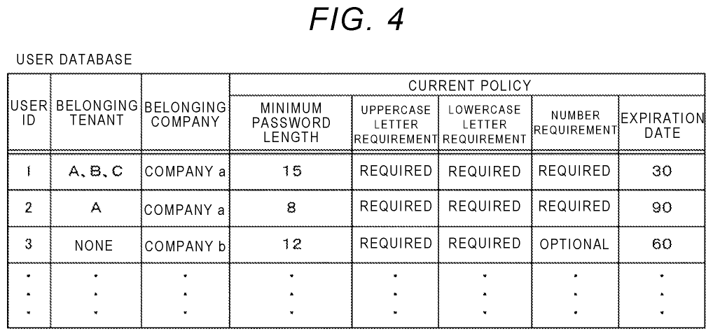

Next, the user database 33G according to the present exemplary embodiment will be described with reference to FIG. 4. In the user database 33G shown in FIG. 4, user information that is information on a user who uses a service by using the user terminal device 10 is stored. In FIG. 4, each row represents the respective user information item. In each user information item, information items of a user ID, a belonging tenant, a belonging company, and a current policy are associated with each other. In each user information item, a user policy that is information indicating a password policy defined by a user, information indicating authentication information by a hash value, information indicating a date/time when the authentication information is set, and a change history of the authentication information are also associated with each other. Further, in each user information item, information indicating the name of a user, information indicating the name of an organization to which the user belongs, and information indicating a mail address of the user are also associated with each other. However, in order to avoid complications, illustrations and descriptions of these user information items are omitted.

The “user ID” is information for individually identifying a user, and is an ID that is assigned in advance as information different for each user.

The “belonging tenant” is information indicating a tenant ID of a tenant to which a corresponding user belongs. As shown in FIG. 4, a belonging tenant corresponding to a user who does not belong to any tenant is stored as “none”.

The “belonging company” is information indicating the name of a company to which a corresponding user belongs.

The “current policy” is information indicating a first current policy, which is a password policy to which a condition having the highest security level is applied, for each item of the password policy defined for each of the corresponding belonging tenants. The current policy of the user who does not belong to any tenant stores, for each item of the password policy of the tenant having a contract with the corresponding belonging company, a second current policy that is the password policy to which the condition having the highest security level is applied.

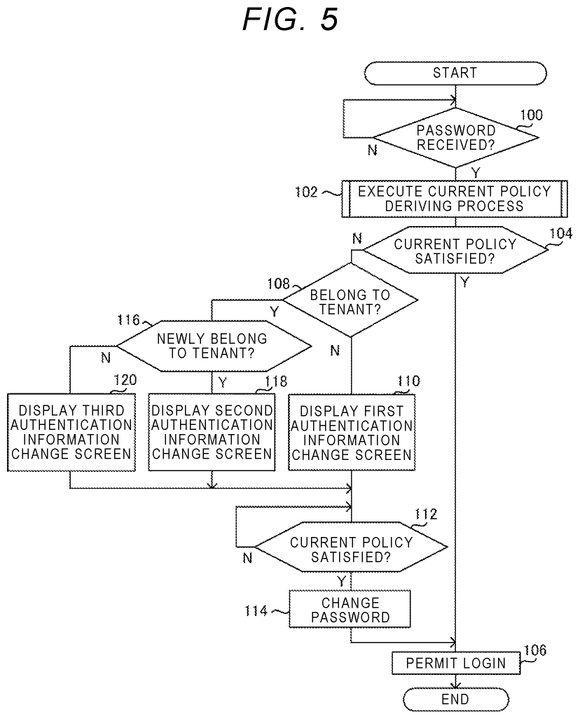

Next, an operation of the information processing apparatus 30 according to the present exemplary embodiment will be described with reference to FIGS. 5 to 19. First, an operation of the information processing apparatus 30 in a case of executing information processing will be described with reference to FIGS. 5 to 9. When a user gives, via the input unit 12, an instruction to start the execution of the information processing program 33A, the CPU 31 of the information processing apparatus 30 executes the information processing program 33A, so that the information processing shown in FIG. 5 is executed.

In step 100, the CPU 31 stands by until the authentication information (hereinafter, simply referred to as “password”) for using services corresponding to all tenants to which a user belongs is received from the input unit 12 via the communication I/F unit 38.

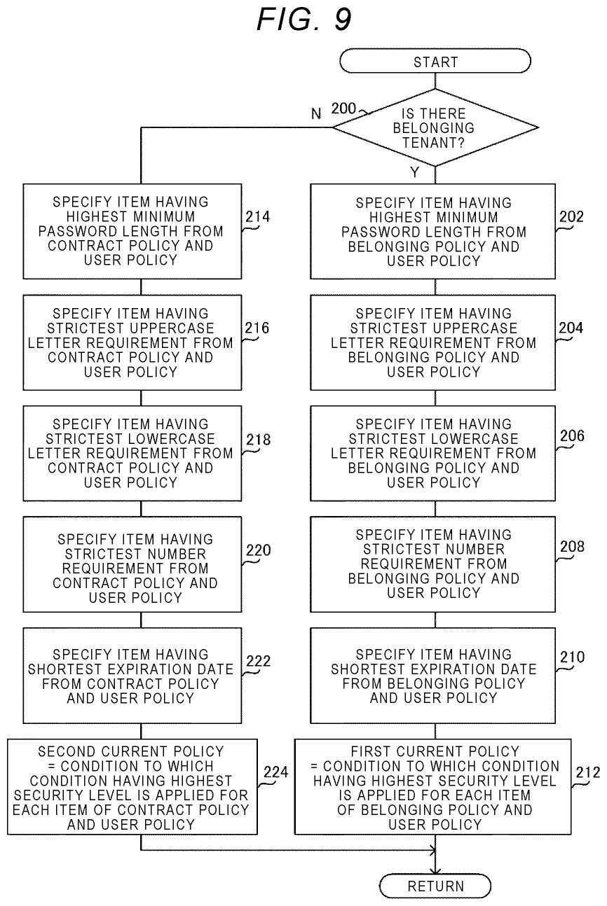

In step 102, the CPU 31 executes a current policy deriving process, which is a process of deriving a current policy corresponding to the user. The current policy deriving process according to the present exemplary embodiment will be described later with reference to FIG. 9.

In step 104, the CPU 31 determines whether the password received in step 100 satisfies the current policy derived in step 102. When the CPU 31 makes an affirmative determination in the processing of step 104, the process proceeds to step 106.

The CPU 31 may determine, in step 104, whether a password stored in advance in the storage 33 satisfies the current policy derived in step 102 without executing step 100. When the CPU 31 makes an affirmative determination, the process proceeds to step 106. In step 104, the CPU 31 determines whether a current policy stored in advance in the user database 33G has a security level higher than that of the current policy derived in step 102. When the CPU 31 makes an affirmative determination, the process proceeds to step 106.

In step 106, the CPU 31 permits login, and the information processing ends. In other words, the CPU 31 enables the user to use all the services corresponding to the tenants to which the user belongs, and the information processing ends.

On the other hand, when the CPU 31 makes a negative determination in the processing of step 104, the process proceeds to step 108. In step 108, the CPU 31 reads a belonging tenant corresponding to the user from the user database 33G, and determines whether the user belongs to the tenant. In other words, the CPU 31 determines whether the current policy is the first current policy. When the CPU 31 makes a negative determination in the processing of step 108, the process proceeds to step 110.

In step 110, the CPU 31 displays a first authentication information change screen according to a predetermined format on the display 14.

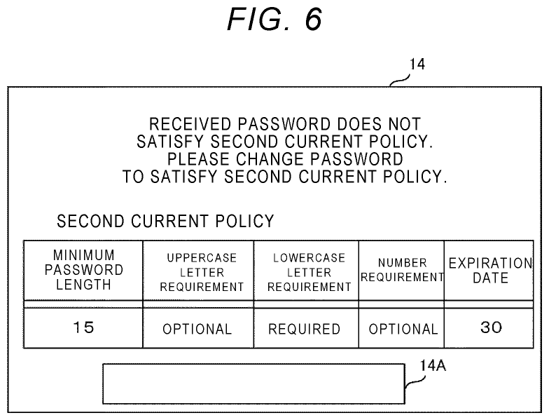

As shown in FIG. 6, the first authentication information change screen according to the present exemplary embodiment displays a message indicating that the password received in step 100 does not satisfy the second current policy, and a message that prompts to change the password so as to satisfy the second current policy. The first authentication information change screen according to the present exemplary embodiment also displays the second current policy. The user enters a changed password into a password entry field 14A via the input unit 12.

In step 112, the CPU 31 stands by until the password received in the processing of step 110, step 118, or step 120 satisfies the current policy corresponding to the user.

In step 114, the CPU 31 stores the password received in the processing of step 110, step 118, or step 120 in the storage 33 as the password corresponding to the user.

On the other hand, when the CPU 31 makes an affirmative determination in the processing of step 108, the process proceeds to step 116. In step 116, the CPU 31 reads the storage 33, and determines whether the first current policy is changed since the user newly belongs to a tenant in a user setting process to be described later. In other words, in step 116, the CPU 31 determines whether the password policy defined for the tenant to which the user newly belongs has a security level higher than that of the first current policy stored in advance. When the CPU 31 makes an affirmative determination in the processing of step 116, the process proceeds to step 118.

In step 118, the CPU 31 displays a second authentication information change screen according to a predetermined format on the display 14.

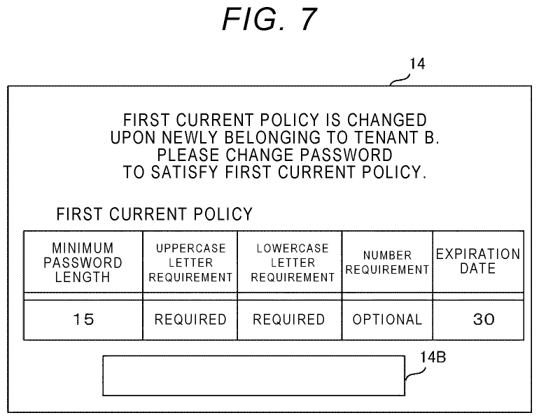

As shown in FIG. 7, the second authentication information change screen according to the present exemplary embodiment displays a message indicating that the first current policy is changed due to the new belonging to the tenant, and a message that prompts to change the password so as to satisfy the first current policy. The second authentication information change screen according to the present exemplary embodiment also displays the first current policy. The user enters a changed password into a password entry field 14B via the input unit 12.

On the other hand, when the CPU 31 makes a negative determination in the processing of step 116, the process proceeds to step 120. In step 120, the CPU 31 displays a third authentication information change screen according to a predetermined format on the display 14.

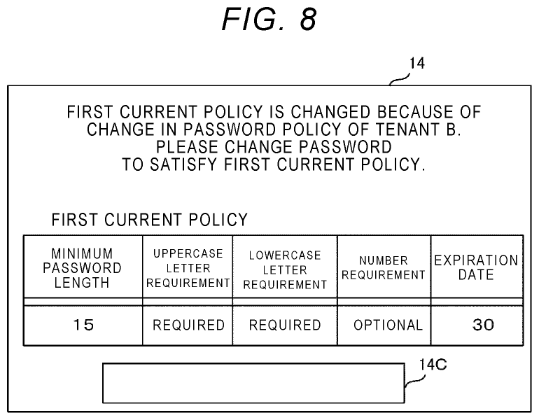

As shown in FIG. 8, the third authentication information change screen according to the present exemplary embodiment displays a message indicating that the first current policy is changed in response to a change of the password policy corresponding to the belonging tenant, and prompting to change the password so as to satisfy the first current policy. The third authentication information change screen according to the present exemplary embodiment also displays the first current policy. The user enters a changed password into a password entry field 14C via the input unit 12.

In step 110, step 118, or step 120, the CPU 31 may present the messages and the current policy displayed on the screen, by voice via a speaker of the user terminal device 10.

In the present exemplary embodiment, a case in which when the received password satisfies the current policy (step 104: Y), the CPU 31 always does not present the message that prompts to change the password will be described. However, when the received password satisfies the current policy, the CPU 31 may present a message that prompts to change a password having a security level lower than that of the currently set password and satisfying the current policy.

Next, the current policy deriving process according to the present exemplary embodiment will be described in detail with reference to FIG. 9.

In step 200, the CPU 31 reads the belonging tenant corresponding to the user from the user database 33G, and determines whether there is a tenant to which the user belongs to. When the CPU 31 makes an affirmative determination in the processing of step 200, the process proceeds to step 202.

In step 202, the CPU 31 specifies an item having the highest minimum password length from the password policy (hereinafter, referred to as “belonging policy”) corresponding to the belonging tenant and the user policy registered by a user policy registration process to be described later. Specifically, the CPU 31 reads the minimum password lengths corresponding to all the belonging tenants from the tenant database 33F, and specifies an item having the longest minimum password length from all the read minimum password lengths and the minimum password length corresponding to the user policy.

In step 204, the CPU 31 specifies an item having the highest security level of the uppercase letter requirement from the belonging policy and the user policy. Specifically, the CPU 31 reads the uppercase letter requirement corresponding to all the belonging tenants from the tenant database 33F, and specifies an item having the highest security level from all the read uppercase letter requirements and the uppercase letter requirement corresponding to the user policy. For example, when there is an item defining that the use an uppercase letter is required among all the uppercase letter requirements read from the tenant database 33F and the uppercase letter requirement corresponding to the user policy, the CPU 31 specifies the item defining that the use of an uppercase letter is required.

In step 206, the CPU 31 specifies an item having the highest security level of the lowercase letter requirement from the belonging policy and the user policy. Specifically, the CPU 31 reads the lowercase letter requirement corresponding to all the belonging tenants from the tenant database 33F, and specifies an item having the highest security level from all the read lowercase letter requirements and the lowercase letter requirement corresponding to the user policy. For example, when there is an item defining that the use of a lowercase letter is required among all the lowercase letter requirements read from the tenant database 33F and the lowercase letter requirement corresponding to the user policy, the CPU 31 specifies the item defining that the use of a lowercase letter is required.

In step 208, the CPU 31 specifies an item having the highest security level of the number requirement. Specifically, the CPU 31 reads the number requirement corresponding to all the belonging tenants from the tenant database 33F, and specifies an item having the highest security level from all the read number requirements and the number requirement corresponding to the user policy. For example, when there is an item defining that the use of a number is required among all the number requirements read from the tenant database 33F and the number requirement corresponding to the user policy, the CPU 31 specifies the item defining that the use of a number is required.

In step 210, the CPU 31 specifies an item having the shortest expiration date from the belonging policy and the user policy. Specifically, the CPU 31 reads the expiration dates corresponding to all the belonging tenants from the tenant database 33F, and specifies the shortest item from all the read expiration dates and the expiration date corresponding to the user policy.

In step 212, the CPU 31 stores the first current policy to which the conditions specified from step 202 to step 210 are applied in the user database 33G as the current policy corresponding to the user. Then, the process proceeds to step 104 of the information processing.

On the other hand, when the CPU 31 makes a negative determination in the processing of step 200, the process proceeds to step 214. In step 214, the CPU 31 specifies an item having the highest minimum password length from the password policy (hereinafter, referred to as “contract policy”) corresponding to the tenant having a contract with the belonging company and the user policy. Specifically, first, the CPU 31 reads the corresponding belonging company from the user database 33G. Next, from the tenant database 33F, the CPU 31 specifies all the contract companies that match the read belonging company, and reads all the minimum password lengths corresponding to the specified contract companies. Next, the CPU 31 specifies an item having the highest minimum password length from all the read minimum password lengths and the minimum password length corresponding to the user policy.

In step 216, the CPU 31 specifies an item having the highest security level of the uppercase letter requirement from the contract policy and the user policy. Specifically, the CPU 31 reads, from the tenant database 33F, all the uppercase letter requirements corresponding to the contract companies that match the belonging company. Next, the CPU 31 specifies an item having the highest security level from all the read uppercase letter requirements and the uppercase letter requirement corresponding to the user policy. For example, when there is an item defining that the use an uppercase letter is required among all the uppercase letter requirements read from the tenant database 33F and the uppercase letter requirement corresponding to the user policy, the CPU 31 specifies the item defining that the use of an uppercase letter is required.

In step 218, the CPU 31 specifies an item having the highest security level of the lowercase letter requirement from the contract policy and the user policy. Specifically, the CPU 31 reads, from the tenant database 33F, all the lowercase letter requirement corresponding to the contract companies that match the belonging company. Next, the CPU 31 specifies an item having the highest security level from all the read lowercase letter requirements and the lowercase letter requirement corresponding to the user policy. For example, when there is an item defining that the use of a lowercase letter is required among all the lowercase letter requirements read from the tenant database 33F and the lowercase letter requirement corresponding to the user policy, the CPU 31 specifies the item defining that the use of a lowercase letter is required.

In step 220, the CPU 31 specifies an item having the highest security level of the number requirement from the contract policy and the user policy. Specifically, the CPU 31 reads, from the tenant database 33F, all the number requirement corresponding to the contract companies that match the belonging company. Next, the CPU 31 specifies an item having the highest security level from all the read number requirements and the number requirement corresponding to the user policy. For example, when there is an item defining that the use of a number is required among all the number requirements read from the tenant database 33F and the number requirement corresponding to the user policy, the CPU 31 specifies the item defining that the use of a number is required.

In step 222, the CPU 31 specifies an item having the shortest expiration date from the contract policy and the user policy. Specifically, the CPU 31 reads, from the tenant database 33F, all the expiration dates corresponding to the contract companies that match the belonging company. Next, the CPU 31 specifies an item having the shortest expiration date from all the read expiration dates and the expiration date corresponding to the user policy.

In step 224, the CPU 31 stores the second current policy to which the conditions specified from step 214 to step 222 are applied in the user database 33G as the current policy, and the process proceeds to step 104 of the information processing.

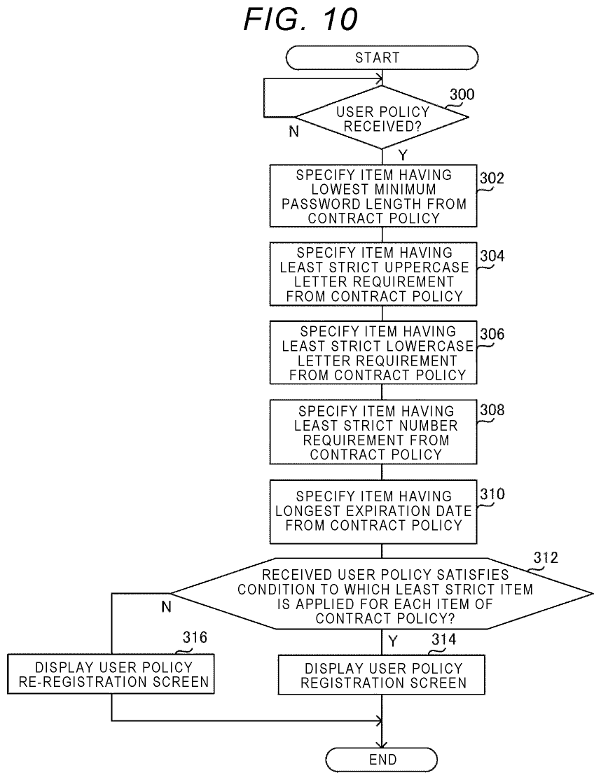

Next, the user policy registration process according to the present exemplary embodiment will be described in detail with reference to FIGS. 10 to 12. When a user gives, via the input unit 12, an instruction to start the execution of the user policy registration program 33B, the CPU 31 of the information processing apparatus 30 executes the user policy registration program 33B, so that the user policy registration process shown in FIG. 10 is executed.

In step 300, the CPU 31 stands by until the user policy, which is the password policy defined by the user, is received from the input unit 12 via the communication I/F unit 38.

In step 302, the CPU 31 specifies an item having the lowest minimum password length from the contract policy. Specifically, first, the CPU 31 reads the corresponding belonging company from the user database 33G. Next, from the tenant database 33F, the CPU 31 specifies all the contract companies that match the read belonging company, and reads all the minimum password lengths corresponding to the specified contract companies. Next, the CPU 31 specifies an item having the lowest minimum password length from all the read minimum password lengths.

In step 304, the CPU 31 specifies an item having the lowest security level of the uppercase letter requirement from the contract policy. Specifically, the CPU 31 reads all the uppercase letter requirements corresponding to the contract company from the tenant database 33F, and specifies an item having the lowest security level from all the read uppercase letter requirements. For example, when there is an item defining that the use of an uppercase letter is optional among all the uppercase letter requirements read from the tenant database 33F, the CPU 31 specifies the item defining the use of an uppercase letter is optional.

In step 306, the CPU 31 specifies an item having the lowest security level of the lowercase letter requirement from the contract policy. Specifically, the CPU 31 reads the lowercase letter requirement corresponding to the contract company from the tenant database 33F, and specifies an item having the lowest security level from all the read lowercase letter requirements. For example, when there is an item defining that the use of a lowercase letter is optional among all the lowercase letter requirements read from the tenant database 33F, the CPU 31 specifies the item defining the use of a lowercase letter is optional.

In step 308, the CPU 31 specifies an item having the lowest security level of the number requirement from the contract policy. Specifically, the CPU 31 reads the number requirement corresponding to the contract company from the tenant database 33F, and specifies an item having the lowest security level from all the read number requirements. For example, when there is an item defining that the use of a number is optional among all the number requirement read from the tenant database 33F, the CPU 31 specifies the item defining the use of a number is optional.

In step 310, the CPU 31 specifies an item having the longest expiration date from the contract policy. Specifically, the CPU 31 reads the expiration dates corresponding to the contract company from the tenant database 33F, and specifies an item having the longest expiration date from all the read expiration dates.

In step 312, the CPU 31 determines whether all the items of the user policy received in step 300 have a security level higher than that of the items specified in steps 302 to 310. When the CPU 31 makes an affirmative determination in the processing of step 312, the process proceeds to step 314. When the CPU 31 makes a negative determination, the process proceeds to step 316.

In step 312, the CPU 31 may determine whether the number of items in the received user policy that have a security level higher than that of the items specified in steps 302 to 310 is equal to or greater than a predetermined number.

In step 314, the CPU 31 displays a user policy registration screen according to a predetermined format on the display 14, and the user policy registration process ends.

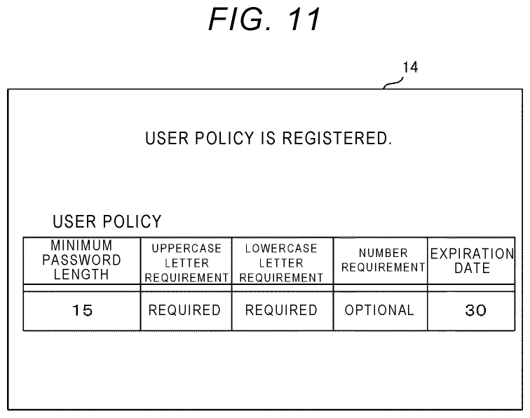

As shown in FIG. 11, the user policy registration screen according to the present exemplary embodiment displays a message indicating that the user policy received in step 300 is to be registered as a user policy, and a user policy to be registered.

In step 314, the CPU 31 may present the message and the user policy to be registered by voice via the speaker of the user terminal device 10.

In step 316, the CPU 31 displays a user policy re-registration screen according to a predetermined format on the display 14, and the user policy registration process ends.

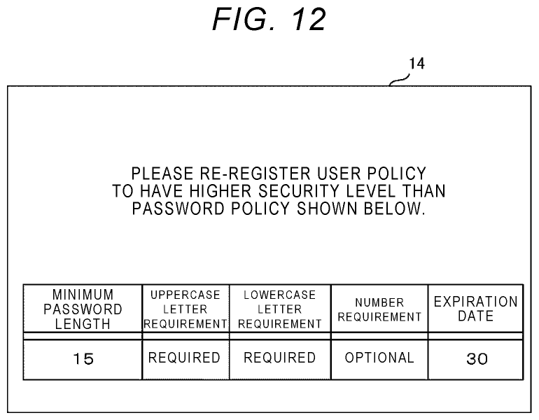

As shown in FIG. 12, the user policy re-registration screen according to the present exemplary embodiment displays the password policy specified in steps 302 to 310. Further, the user policy re-registration screen according to the present exemplary embodiment also displays a message that prompts to re-register the user policy to have a higher security level than the displayed password policy.

In step 316, the CPU 31 may present the password policy specified in steps 302 to 310 and the message by voice via the speaker of the user terminal device 10.

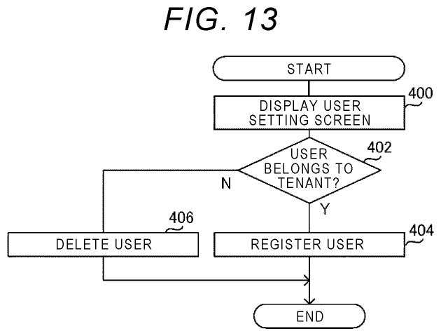

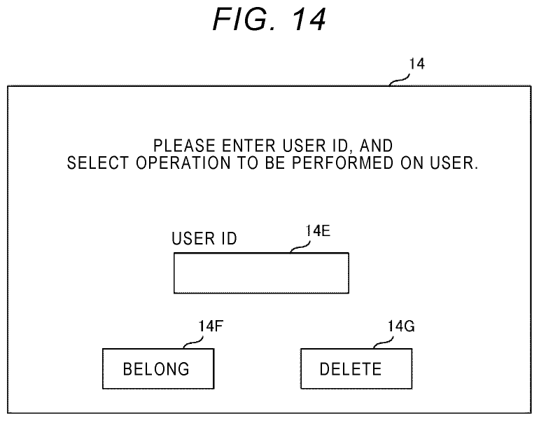

Next, the user setting process according to the present exemplary embodiment will be described in detail with reference to FIGS. 13 and 14. When the administrator gives, via the input unit 12, an instruction to start the execution of the user setting program 33C, the CPU 31 of the information processing apparatus 30 executes the user setting program 33C, so that the user setting process shown in FIG. 13 is executed.

In step 400, the CPU 31 displays a user setting screen according to a predetermined format on the display 14.

As shown in FIG. 14, the user setting screen according to the present exemplary embodiment displays a message that prompts to enter a user ID, and select an operation for causing the entered user ID to belong to a managed tenant or an operation for deleting the user from the managed tenant. The administrator first enters a user ID to a user ID entry field 14E via the input unit 12. Then, in the case of causing the user ID entered in the user ID entry field 14E to belong to a managed tenant, the administrator selects a “belong” button 14F via the input unit 12. In the case of deleting the user ID entered in the user ID entry field 14E from the managed tenant, the administrator selects a “delete” button 14G via the input unit 12.

In step 402, the CPU 31 determines whether the “belong” button 14F is selected on the user setting screen. When the CPU 31 makes an affirmative determination in the processing of step 402, the process proceeds to step 404. When the CPU 31 makes a negative determination, the process proceeds to step 406.

In step 404, the CPU 31 adds the tenant managed by the administrator to the belonging tenant corresponding to the user ID entered in the user ID entry field 14E in the user database 33G, and the user setting process ends.

In step 406, the CPU 31 deletes the tenant managed by the administrator from the belonging tenant corresponding to the user ID entered in the user ID entry field 14E in the user database 33G, and the user setting process ends.

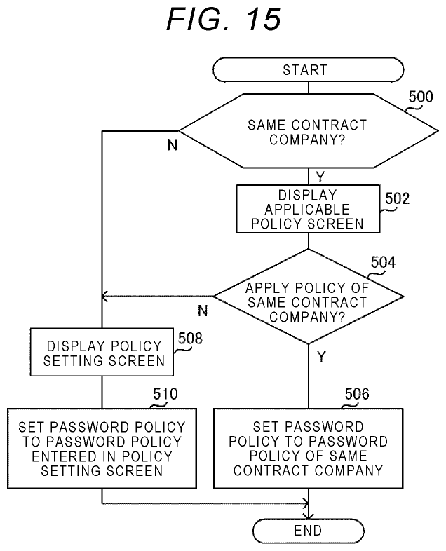

Next, a policy setting process according to the present exemplary embodiment will be described in detail with reference to FIGS. 15 to 17. When the administrator gives, via the input unit 12, an instruction to start the execution of the policy setting program 33D, the CPU 31 of the information processing apparatus 30 executes the policy setting program 33D, so that the policy setting process shown in FIG. 15 is executed.

In step 500, the CPU 31 reads the tenant database 33F and determines whether there is a tenant having a contract with the same company as the company having a contract with the managed tenant. When the CPU 31 makes an affirmative determination in the processing of step 500, the process proceeds to step 502. When the CPU 31 makes a negative determination, the process proceeds to step 508.

In step 502, the CPU 31 displays an applicable policy screen according to a predetermined format on the display 14.

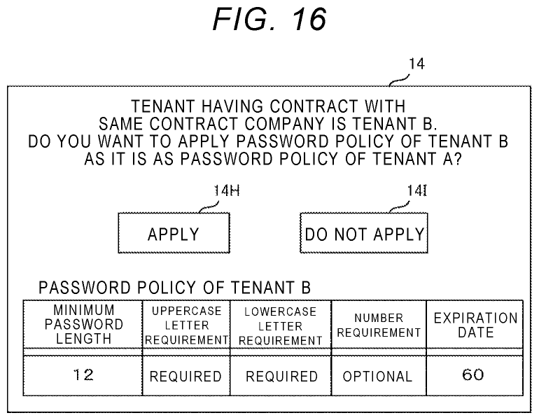

As shown in FIG. 16, the applicable policy screen according to the present exemplary embodiment displays a message indicating that there is a tenant having a contract with the same company as the company having a contract with the managed tenant, and a password policy defined for the tenant having a contract with the same company. The administrator selects, via the input unit 12, an “apply” button 14H when the administrator wants to apply the password policy defined for the tenant having a contract with the same company as it is as a password policy of the managed tenant, and a “do not apply” button 141 when the administrator does not want to apply the password policy defined for the tenant having a contract with the same company.

In step 504, the CPU 31 determines whether the “apply” button 14H is selected on the applicable policy screen. When the CPU 31 makes an affirmative determination in the processing of step 504, the process proceeds to step 506. When the CPU 31 makes a negative determination, the process proceeds to step 508.

In step 506, the CPU 31 stores, as the password policy of the managed tenant in the tenant database 33F, the password policy defined for the tenant having a contract with the same company, and the policy setting process ends.

In step 508, the CPU 31 displays a policy setting screen according to a predetermined format on the display 14.

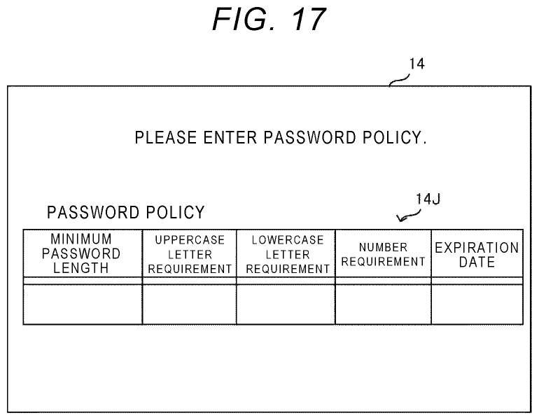

As shown in FIG. 17, the policy setting screen according to the present exemplary embodiment displays a message that prompts to enter a password policy. The administrator enters the password policy of the managed tenant into a password policy entry field 14J via the input unit 12.

In step 510, the CPU 31 stores the password policy entered in the password policy entry field 14J of the policy setting screen as the password policy of the managed tenant in the tenant database 33F, and the policy setting process ends.

In the case where the CPU 31 sets the password policy by the processing of step 506, when the applied password policy is changed by a policy change process to be described later, the set password policy may be changed by following the policy change process.

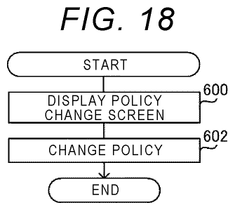

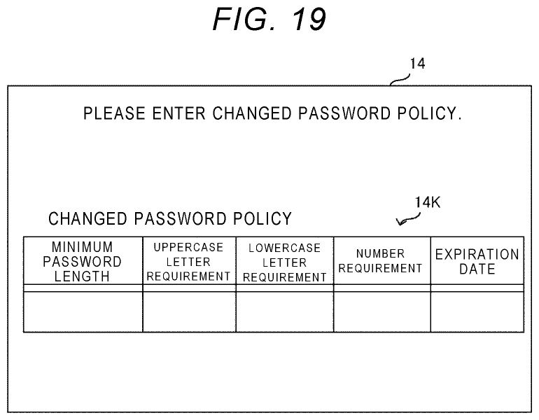

Next, the policy change process according to the present exemplary embodiment will be described in detail with reference to FIGS. 18 and 19. When the administrator gives, via the input unit 12, an instruction to start the execution of the policy changing program 33E, the CPU 31 of the information processing apparatus 30 executes the policy changing program 33E, so that the policy change process shown in FIG. 18 is executed.

In step 600, the CPU 31 displays a policy change screen according to a predetermined format on the display 14.

As shown in FIG. 19, the policy change screen according to the present exemplary embodiment displays a message that prompts to enter a changed password policy. The administrator enters the changed password policy of the managed tenant into a changed password policy entry field 14K via the input unit 12.

In step 602, the CPU 31 overwrites the password policy of the managed tenant in the tenant database 33F with the password policy entered in the changed password policy entry field 14K of the policy change screen, and the policy change process ends.

The CPU 31 may execute the information processing after executing the user setting process or the policy change process. In this case, the CPU 31 derives the current policy without executing step 100 in the information processing, and when the password stored in advance in the storage 33 does not satisfy the derived current policy, the CPU 31 presents the message that prompts to change the password. When the current policy stored in advance in the user database 33G has a security level lower than that of the derived current policy, the CPU 31 may present the message that prompts to change the password.

When all the items of the current password policy have a lower security level than items having the lowest security level among the items of the belonging policy, the contract policy, and the user policy, the CPU 31 may present the message that prompts to change the password.

Although the exemplary embodiment has been described above, the technical scope of the present disclosure is not limited to the above exemplary embodiment. Various modifications or improvements can be made to the above-described exemplary embodiment without departing from the gist of the disclosure, and the modified or improved exemplary embodiments are also included in the technical scope of the present disclosure.

Further, the above exemplary embodiment does not limit the disclosure according to the claims, and all combinations of the features described in the exemplary embodiment are not necessarily essential to the solution of the disclosure. The exemplary embodiment described above includes disclosures at various stages, and various disclosures are extracted by a combination of plural disclosed constituent elements. Even when some constituent elements are deleted from all the constituent elements shown in the exemplary embodiment, a configuration in which some constituent elements are deleted can be extracted as disclosure as long as an effect is obtained.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

In the present exemplary embodiment, a form in which the information processing program 33A is installed in the storage 33 has been described, but the disclosure is not limited thereto. The information processing program 33A according to the present exemplary embodiment may be provided in a form of being recorded in a computer readable storage medium. For example, the information processing program 33A according to the present exemplary embodiment may be provided in a form of being recorded on an optical disc such as a compact disc ROM (CD-ROM) and a digital versatile disc ROM (DVD-ROM), or in a form of being recorded on a semiconductor memory such as a universal serial bus (USB) memory and a memory card. The information processing program 33A according to the present exemplary embodiment may be acquired from an external device via the communication I/F unit 38.

In the above-described exemplary embodiment, the case in which the information processing is implemented by the software configuration using a computer by executing the program has been described, and the present disclosure is not limited thereto. For example, the information processing may be implemented by a hardware configuration or a combination of the hardware configuration and the software configuration.

In addition, the configuration of the information processing apparatus 30 described in the above exemplary embodiment is an example, and it is obvious that unnecessary portions may be deleted or new portions may be added without departing from the gist of the present disclosure.

The flow of the processing of the information processing program described in the above exemplary embodiment (see FIG. 5) is also an example, and it is needless to say that unnecessary steps may be deleted, new steps may be added, or a processing order may be changed without departing from the gist of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive authentication information for using a group that manages use of a service; and
when the received authentication information does not satisfy a first current condition that is a condition of authentication information to which a condition having a highest security level is applied, for each item of a condition of the authentication information defined for each group to which a user belongs, present information that prompts to change the authentication information.

2. The information processing apparatus according to claim 1, wherein the processor is configured to:
receive a condition of the authentication information from the user; and
even when the received authentication information satisfies the first current condition, when the received authentication information does not satisfy the condition of the authentication information received from the user, present the information that prompts to change the authentication information.

3. The information processing apparatus according to claim 2, wherein the processor is configured to:
receive a condition of the authentication information from the user; and
when a security level of the received condition of the authentication information is lowest among items corresponding to the received condition of the authentication information and a condition of the authentication information defined for a group having a contract with a company to which the user belongs, present the information that prompts to change the received condition of the authentication information.

4. The information processing apparatus according to claim 1, wherein the processor is configured to:
when the processor receives the authentication information from a user who does not belong to the group, and when the received authentication information does not satisfy a second current condition that is a condition of authentication information to which a condition having a highest security level is applied, for each item of a condition of the authentication information defined for a group having a contract with a company to which the user belongs, present the information that prompts to change the authentication information.

5. The information processing apparatus according to claim 4, wherein the processor is configured to:
receive a condition of the authentication information from the user who does not belong to the group; and
even when the received authentication information satisfies the second current condition, when the received authentication information does not satisfy the condition of the authentication information received from the user who does not belong to the group, present the information that prompts to change the authentication information.

6. A non-transitory computer readable medium storing a program causing a computer to execute information processing, the information processing comprising:
receiving authentication information for using a group that manages use of a service; and
when the received authentication information does not satisfy a first current condition that is a condition of authentication information to which a condition having a highest security level is applied, for each item of a condition of the authentication information defined for each group to which a user belongs, presenting information that prompts to change the authentication information.

7. An information processing method comprising:
receiving authentication information for using a group that manages use of a service; and
when the received authentication information does not satisfy a first current condition that is a condition of authentication information to which a condition having a highest security level is applied, for each item of a condition of the authentication information defined for each group to which a user belongs, presenting information that prompts to change the authentication information.
